(19) United States
(12) Patent Application Publication
(10) Pub. No.: US 2015/0001157 A1
(43) Pub. Date: Jan. 1, 2015

(54) METHODS AND APPARATUS FOR MULTI-PART TREATMENT OF LIQUIDS CONTAINING CONTAMINANTS USING ZERO VALENT NANOPARTICLES

(71) Applicant: Corning Incorporated, Corning, NY (US)

(72) Inventor: Benedict Yorke Johnson, Horseheads, NY (US)

(21) Appl. No.: 13/927,905

(22) Filed: Jun. 26, 2013

(51) Int. Cl. C02F 1/28

(52) U.S. Cl. CPC C02F 1/288
USPC 210/688

(57) ABSTRACT

Methods and apparatus provide for subjecting water contaminated with one or more heavy metals to an ion exchange process such that a total quantity of anions within the water are reduced; and subsequent to the anion exchange process, bringing the contaminated water into contact with zero valent nanoparticles to remove at least some of the heavy metal from the water.

### BACKGROUND

The present disclosure relates to methods and apparatus for a multi-part treatment of liquids containing contaminants using zero valent nanoparticles.

It is clearly desirable to reduce the levels of heavy metals in surface waters, such as streams, rivers and lakes. Such heavy metal contaminants include: cadmium, chromium, copper, lead, mercury, nickel, zinc, and semi-metals such as arsenic and selenium. High concentrations of heavy metals in the environment can be detrimental to a variety of living species, and ingestion of these metals by humans in sufficient quantities can cause accumulative poisoning, cancer, nervous system damage, and ultimately death.

Selenium is a naturally occurring chemical element in rocks, soils, and natural waters. Selenium is also widely used in manufacturing industries, such as electronics manufacturing, fertilizer manufacturing, fungicide manufacturing, shampoo manufacturing, and many others. Inorganic selenium is most commonly found in four oxidation states (Se⁶⁺, Se³⁺, Se^{C}, Se²⁻). Selenate (SeO₄²⁻, Se(VI)) and selenite ((SeO₃²⁻, Se(IV)) are highly water soluble, while elemental selenium is insoluble in water. Like the other heavy metals mentioned above, selenium is a water contaminant that represents a major environmental problem.

Coal-fired power plants and waste incinerators are major sources of heavy metals. Specifically, power plants and incinerators that have flue gas desulfurization systems (wet FGDs) are of concern because wastewater in the purge stream in such systems often contains mercury, selenium and/or arsenic. Of course, heavy metal contamination, including selenium contamination, is not limited to mining and refining of coal and has been identified as an issue in agricultural drainage and municipal wastewater applications as well.

For example, among the sources of selenium are the mining of copper and uranium, which bear ores and sulfur deposits. Selenium is found in wastewater of such mining in concentrations ranging from a few ug/L (micrograms per liter) up to more than 12 mg/L. In precious metal operations, waste and process water and heap leachate solutions may contain selenium at concentrations up to 30 mg/L. In flue gas desulfurization wastewater, selenium exist in various forms ranging from dozens of ppb to over 5 ppm, where selenite may account from more than half of the total quantity of selenium contaminant.

Treatment of selenium in wastewater is often considered to be one of the most difficult of the toxic metal treatments to implement. On the one hand, selenium in small quantities (0.1-0.5 ppm dry weight) is a micronutrient that is part of everyday life. On the other hand, selenium can be toxic at elevated levels and some selenium species may be carcinogenic. It has been observed that concentrations of selenate as low as 10 ug/L in water can cause death and birth deformities in waterfowl. The National Primary Drinking Water Standard is 50 ppb for total selenium and the National Fresh Water Quality Standard is 5 ppb for total selenium (EPA 2001; EPA 2011).

In nature, selenium is most commonly observed as selenate, selenite, or selenide. Though complexed selenium is of low toxicity, selenate (Se(VI)) and selenite (Se(IV)) are very toxic. These latter two forms of selenium are generally found in water, and display bioaccumulation and bioavailability. Under acidic conditions, an extremely toxic and corrosive hydrogen selenide gas can be generated from certain species of selenium. The presence of selenates and/or selenites in waste water is an immediate problem because, if left untreated, water containing these forms of selenium will likely result in a bio-accumulation of selenium and pose a threat to aquatic life downstream.

Governmental regulations for controlling the discharge of industrial wastewater containing dissolved concentrations of heavy metals into the environment are being tightened. In order to meet such regulations, wastewater is often treated to either remove or reduce such heavy metals to levels at which the water is considered safe for both aquatic and human life prior to discharge of the wastewater into the environment. Conventional treatment processes for removal of heavy metals from water are generally based on chemical precipitation and coagulation followed by conventional filtration. The problem with conventional techniques, however, is that they are not likely to remove sufficient metal concentrations to achieve the low ppb levels required by the ever more stringent drinking water standards set by the government.

Accordingly, there are needs in the art for new methods and apparatus for the treatment of liquids containing contaminants in order to remove some or all of the heavy metals that may be contained in solution.

### SUMMARY

One or more embodiments disclosed herein provide processes and apparatus for reducing heavy metals in wastewater effluents, such as those generated by mineral and/or metal processing systems, coal-fired power plant FGD wastewater, etc. Such embodiments provide an environmentally-compatible and simple process for removing dissolved heavy metals from aqueous solutions.

Nanoparticles have been found to be attractive for remediation of various contaminants because of their unique physiochemical properties, especially their high surface area. Indeed, as nanoparticles are extremely small, a high surface area to mass ratio exists, making them much more reactive compared to coarser predecessors, such as iron filings.

Use of Zero valent iron (ZVI) nanoparticles has been emerging as a promising option for removal of heavy metals from industrial wastewaters. ZVI (Fe⁰) nanoparticles have been used in the electronic and chemical industries due to their magnetic and catalytic properties. Use of ZVI nanoparticles is becoming an increasingly popular method for treatment of hazardous and toxic wastes and for remediation of contaminated water. Conventional applications have focused primarily on the electron-donating properties of ZVI. Under ambient conditions, ZVI is fairly reactive in water and can serve as an excellent electron donor, which makes it a versatile remediation material. ZVI nanoparticles, due to their extremely high effective surface area, can enhance the reduction rates markedly. ZVI nanoparticles have been shown to effectively transform and detoxify a wide variety of common environmental contaminants, such as chlorinated organic solvents, organochlorine pesticides, and PCBs, nitrate, hexavalent chromium and various heavy metal ions.

Zero valent iron may be used to treat water containing selenate (Se(VI)) and selenite (Se(IV)). Indeed, when ZVI nanoparticles are added to a waste stream, the ZVI are oxidized to soluble Fe2+ which then reacts with OH— to form green rust. The green rust serves as a reducing agent to reduce Se (VI) and Se (IV) to insoluble selenium.

Despite advances in ZVI nanoparticle technology and modest commercialization, several barriers have prevented its use as a widely adopted remediation option. There are technical challenges that have limited the technology, including problems of application and problems of synthesis.

As for problems in application, although ZVI has shown the potential for removal of Se(VI) and Se(IV) to very low levels, the effectiveness can vary significantly depending on the oxidation state of the selenium as well as the presence of certain additional salts, particularly sulfates, phosphates and nitrates. Indeed, as the level of salts increases in the water the removal of selenium is diminished because more competing anions are present for the sorbent sites.

Additional problems of application include the fact that, in water, ZVI nanoparticles aggregate and eventually settle, thereby making it difficult to carry out a specific reaction efficiently and effectively. In water treatment and metal recovery applications, ZVI nanoparticles may be employed in powder form, granular form and/or fibrous form in batch reactors and column filters. However, within the reactor or filter the ZVI nanoparticles rapidly fuse into a mass due to formation of iron oxides. This fusion significantly reduces the hydraulic conductivity of the iron bed and the efficacy of the treatment rapidly deteriorates.

Among the problems in the syntheses of ZVI nanoparticles is the inherent environmental instability of the particles themselves. Without any protection, ZVI nanoparticles are oxidized as soon as they come in contact with air.

Although some have taken steps to overcome these drawbacks, they have proved to be less than acceptable for low cost and practical water treatment applications. For example, one approach has been to immobilize iron nanoparticles on particulate supports, such as silica, sand, alumina, activated carbon, titania, zeolite, etc., in order to prevent ZVI nanoparticle aggregation and rapid deactivation. Although this approach has enhanced the speed and efficiency of remediation, the problem remains that it requires a follow up filtration, just like processes employing free standing ZVI nanoparticles. Filtration methods, including membrane filtration, reverse osmosis, electrodialysis reversal and nanofiltration are expensive and difficult to implement and operate. Further, disposal of the waste that is generated during water treatment and follow up filtration is also problematic because, for example, membranes consistently clog and foul. A further problem is that the use of a particulate support only addresses the agglomeration of ZVI nanoparticles, but offers no protection against the rapid loss of reactivity due to oxidation.

One or more embodiments herein provide for treatment processes and apparatus for cleaning metal contaminated industrial water (such as selenium), which include a pre-treatment step to reduce competing anions in the water and post-treatment step utilizing zero valent nanoparticles, preferably immobilized and stabilized on substrate. By way of example, the pre-treatment methodologies and/or apparatus provide for treating the wastewater with anion exchange resin to initially reduce the interfering contaminants, such as sulfate ions. In the pre-treatment process, dissolved metals (particularly metal anions such as selenium) are significantly reduced. The post-treatment methodologies and/or apparatus provide for removing any residual metals in the pre-treated water to below a critical threshold using zero valent nanoparticles, which may be immobilized and stabilized on a substrate, such as a porous cellular ceramic substrate.

The advantages of the embodiments herein in water treatment include: (i) reduced complexity (simple equipment), ease of operation and ease of handling before, during after the treatment process; (ii) prevention of zero valent nanoparticle aggregation, and prevention of rapid deactivation, which further enhances the speed and efficiency of remediation; (iii) low cost and minimal use of chemicals because, for example, certain zero valent nanoparticles (e.g., iron) are inexpensive, and the elimination of follow up filtration significantly impacts cost of treatment; and (iv) wide applicability and selectivity as to the metal sorbent(s) to capture.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is a schematic view of a system for treating contaminated water using a multi-part process, including the use of zero valent nanoparticles;

FIG. 2 is a flow chart illustrating some major steps in the multi-part process for treating contaminated water;

FIG. 3 is a schematic view of a structure for immobilizing and stabilizing zero valent nanoparticles on a substrate;

FIG. 4 is a schematic, microscopic view of a portion of a preferred substrate containing immobilized and stabilized zero valent nanoparticles;

FIG. 5 is a perspective view of an embodiment in which the substrate is implemented using a honeycomb structure; and

FIG. 6 is an end view of the honeycomb structure of FIG. 5.

### DETAILED DESCRIPTION OF THE PREFERRED EMBODIMENTS

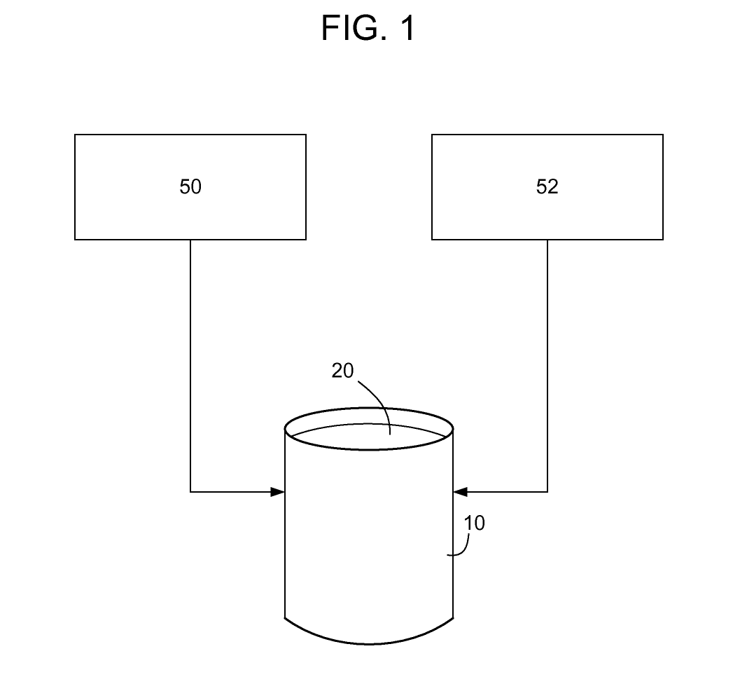

Various embodiments disclosed herein are directed to processes and apparatus for reducing heavy metals in wastewater effluents, such as those generated by mineral and/or metal processing systems, coal-fired power plant FGD wastewater, etc. With reference to FIG. 1, a schematic representation of a treatment system and process shows that contaminated water 20 contained in a vessel 10 is subject to a multi-part process to reduce heavy metal contaminants within the water 20. The methodology to reduce the heavy metal contaminants within the water 20 includes two basic steps: (i) a pre-treatment process (50) to reduce a number of competing anions within the water 20; and (ii) a post treatment process (52) in which the contaminated water is brought into contact with zero valent nanoparticles to remove at least some of the heavy metal from the water 20.

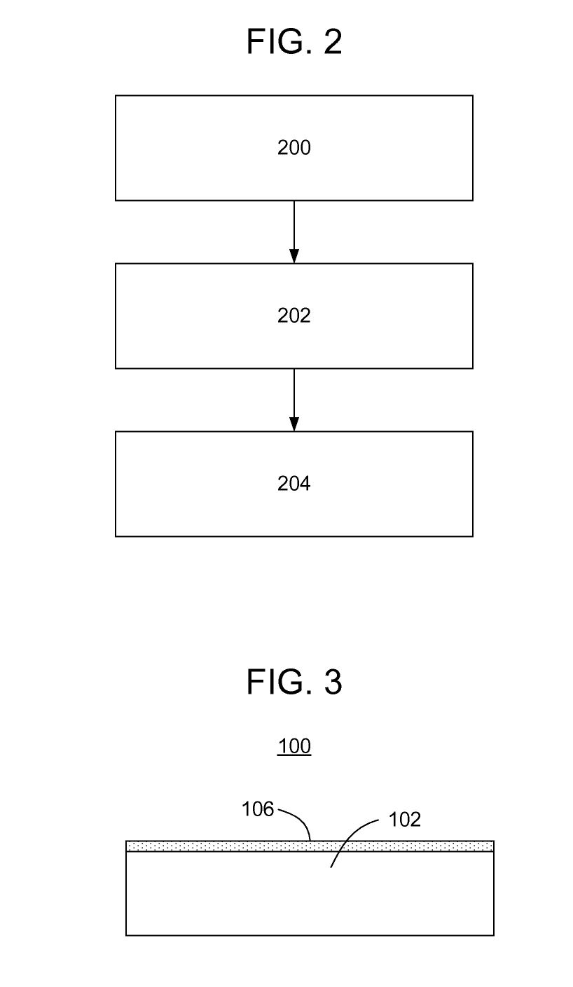

FIG. 2 is a flow chart illustrating some major steps in the multi-part process for treating the contaminated water 20. At step 200, the water 20 is subject to an ion exchange process by adding anion exchange resin beads to the water 20 under agitation (such as moderate stirring) for a period of time sufficient to reduce a total quantity of anions within the water 20. The desired result is to reduce the number of competing anions within the water 20 (such as sulfate ions and/or other ions within the water produced by dissolved salts) that would otherwise inhibit the efficacy of the removal of heavy metal using zero valent nanoparticles in a subsequent processing step (discussed later herein).

In a preferred embodiment, the anion exchange resin beads have pores on the surfaces thereof that serve as sites for trapping anions and releasing ions in exchange. Additionally and/or alternatively, the anion exchange resin beads may be formed from sulphonated cross-linked polystyrene molecules containing exchangeable hydroxide (OH—). The beads may be of a diameter between one of: (i) about 0.4 to 0.8 mm; (ii) about 0.5 to 0.7 mm; and (iii) about 0.54 to 0.64 mm.

There are four main types of anion exchange resin beads, each differing in its functional group, namely: (i) strongly basic, (e.g., quaternary amino groups, for example, trimethylammonium groups such as polyAPTAC); (ii) weakly basic (primary, secondary, and/or ternary amino groups, e.g., polyethylene amine); (iii) weakly acidic (e.g., carboxylic acid groups); and (iv) strongly acidic (e.g., sulfonic acid groups, such as sodium polystyrene sulfonate or polyAMPS). Of these four types, preferred embodiments herein employ the strongly basic variety of anion exchange resin beads.

At step 202, the anion exchange resin beads are separated from the contaminated water 20, which may be accomplished using any of a number of known techniques, such as by decantation. Thereafter, the water 20 is subject to further treatment by facilitating the contact of the water 20 with zero valent nanoparticles in order to reduce the heavy metals therein (step 204).

The contact of the zero valent nanoparticles with the water 20 may be achieved in any number of ways. In accordance with preferred embodiments herein, and with reference to FIG. 3, a structure 100 is employed in which the zero valent nanoparticles 106 are immobilized and stabilized on a substrate 102. The water 20 may contact the zero valent nanoparticles 106 thereby drawing the heavy metal from the water 20 to the substrate 102. By way of example, the structure 100 may be immersed into the contaminated water 20 and agitation may be applied until the heavy metals are removed from the water 20, leaving an acceptable level of contaminants (if any) in the water 20.

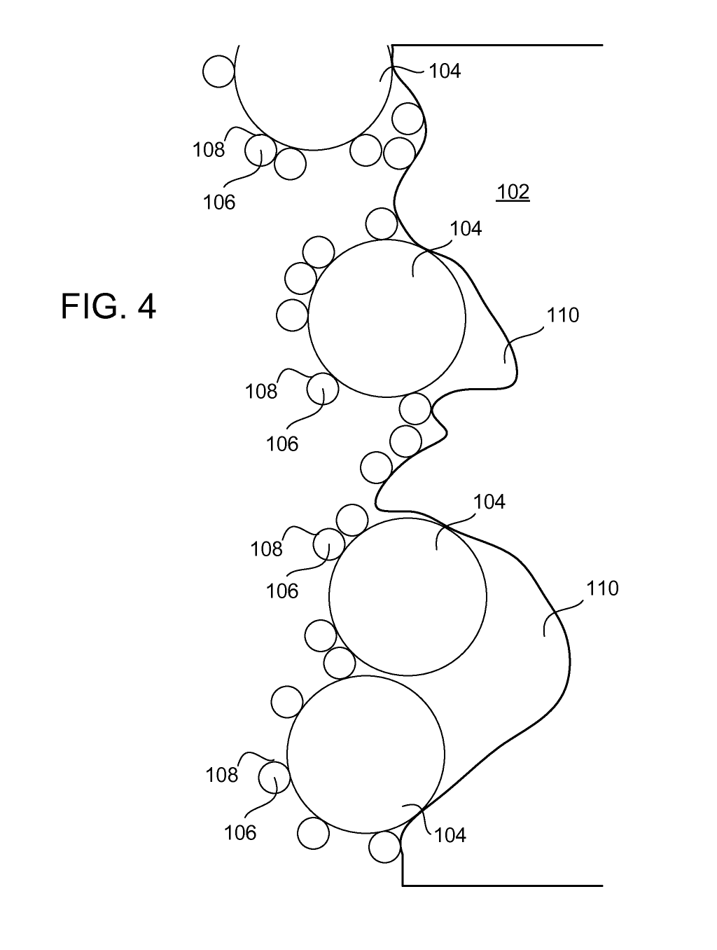

FIG. 4 is a schematic, microscopic view of a portion of the structure 100, provided in order to appreciate certain details concerning the immobilized and stabilized zero valent nanoparticles 106. The structure 100 includes an inorganic substrate 102 having at least one surface and the zero valent nanoparticles 106 are deposited and immobilized on the surface of the substrate 102. The inorganic substrate may be formed from, for example, ceramic or alumina. A stabilizer 108 engages the zero valent nanoparticles 106 and operates to inhibit oxidation of the zero valent nanoparticles 106. The zero valent nanoparticles 106 include at least one of iron, lithium, and nickel.

The substrate 102 is porous, including numerous pores 110, and zero valent nanoparticles 106 are disbursed on the surface of the substrate 102 and within at least some of the pores 110. It is desirable to employ a porous surface in order to increase the available active surface area on which to immobilize the zero valent nanoparticles 106. In this regard, it has been found desirable that the inorganic substrate 102 have a porosity of one of: (i) between about 20%-90%; (ii) between about 40%-70%; and (iii) between about 50%-60%.

In order to increase the available active surface area of the substrate 102, the surface may be coated with an inorganic oxide 104 prior to immobilizing the zero valent nanoparticles 106. Indeed, particles of the inorganic oxide 104 may be coated onto the porous surface of the substrate 102. The inorganic oxide may be one or more of SiO2, Al2O3, CeO2, ZrO2, TiO2, SnO2, MgO, ZnO, Nb2O5, Cr2O3, CdO, and WO3. The change in the microscopic contour of the surface introduced by the geometries of the particles of the inorganic oxide 104 increases the available active surface area of the substrate 102, providing more opportunities and surfaces to immobilize the zero valent nanoparticles 106. In one or more embodiments, the active surface area (intended to receive the zero valent nanoparticles 106) may be considered to be an aggregate of: (i) portions of the surface of the inorganic substrate 102, and (ii) portions of the surfaces particles of the inorganic oxide 104 that are adhered to the surface of the inorganic substrate 102.

In order to effectively treat the contaminated water 20, a large percentage of the available active surface area of the substrate 102 should be covered with the zero valent nanoparticles 106, such as ranging one of: (i) between about 20%-100%; (ii) between about 40%-90%; (iii) between about 50%-90%; and (iv) between about 70%-80%.

It has been found that a relationship between the geometries of the particles of the inorganic oxide 104 and the pores 110 of the substrate 102 should be considered. Indeed, in order to facilitate good adhesion of the particles of the inorganic oxide 104 to the surface, and therefore improve the available active surface area of the substrate 102, the sizes of the pores 110 should be complimentary to the sizes of the particles of the inorganic oxide 104. The contemplated inorganic oxide 104 may exhibit particle diameters of between about: (i) 10 nm to about 100 nm, (ii) about 30 nm-80 nm, and (iii) about 40 nm-50 nm (where about 40 nm is typical). Accordingly, one may seek to provide pores 110 that are large enough to adequately receive the inorganic oxide 104, such as one of: (i) between about 20 nm-30 um; (ii) greater than about 20 nm; and (iii) between about 10 um-30 um. For purposes of discussion, one can see that the ranges for the pore sizes correspond to and/or complement the ranges of the size of the inorganic oxide 104.

The sizes (approximate diameters) of the zero valent nanoparticles 106 range from about 5 nm and higher, such as to about 40-50 nm. Typically, practical and cost-effective methodologies for producing zero valent nanoparticles 106 will result in particle sizes of between about 5 nm to about 10 nm at the low end of the scale. For purposes of the embodiments herein, it is desirable to employ zero valent nanoparticles 106 with relatively small diameters in order to maximize the surface area available to remove the heavy metal contaminants from the water 20.

A stabilizer 108 may be applied to the zero valent nanoparticles 106 in order to inhibit oxidation, which is an inherent problem with such material. The stabilizer 108 may include at least one of activated carbon, graphene, and an inorganic oxide, for example, SiO2, Al2O3, CeO2, ZrO2, TiO2, SnO2, MgO, ZnO, Nb2O5, Cr2O3, CdO, and/or WO3. Alternatively or additionally, the stabilizer 108 may include organic, polymer materials, such as: xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof. The stabilizer 108 may wholly or partially coat the zero valent nanoparticles 106.

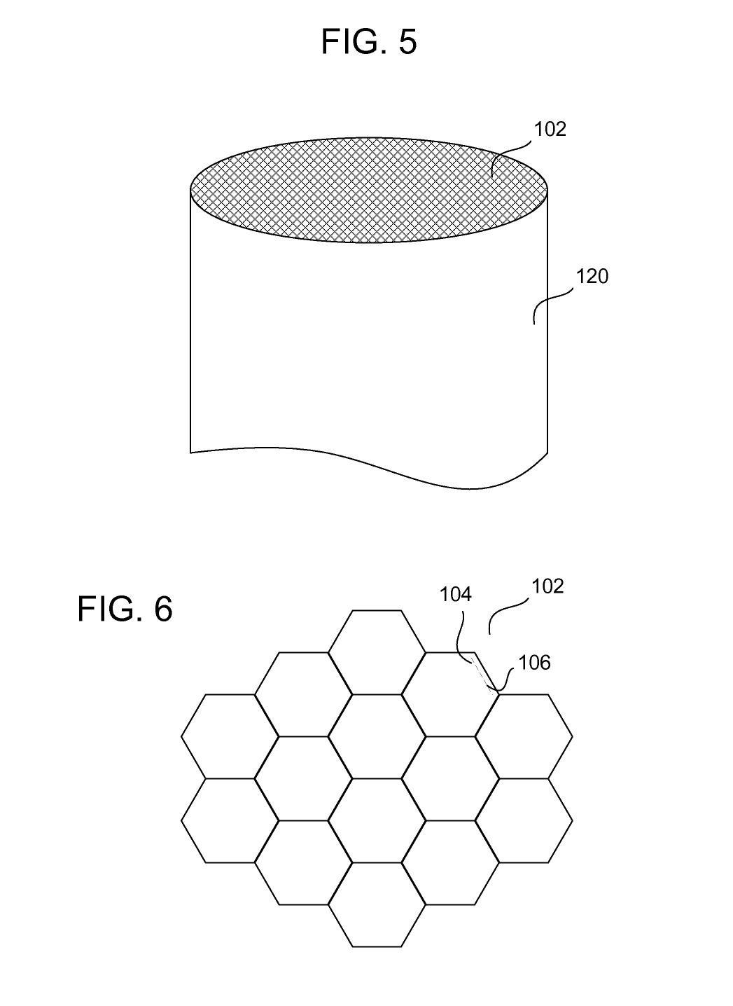

With reference to FIGS. 5 and 6, a preferred configuration is illustrated. FIG. 5 is a perspective view of an embodiment in which a number of substrates 102 are integrated into a honeycomb structure 120, and FIG. 6 is an end view of the honeycomb structure 120. Accordingly, the honeycomb structure 120 includes a plurality of parallel channels, where each channel is formed by a plurality of interior surfaces formed using the basic structure the substrate 102. Thus, in FIG. 6, reference is made to the inorganic oxide 104 and the zero valent nanoparticles 106 on the interior surfaces of the honeycomb channels. In order to treat wastewater 20 contaminated with one or more heavy metals, the water 20 is directed to flow through the cells of the honeycomb 120, which brings the contaminated water 20 into contact with the surfaces containing the immobilized zero valent nanoparticles 106. Consequently, the heavy metal is removed (at least partially) from the water 20.

It is noted that the channels of the honeycomb structure 120 are defined by respective walls, each of which may be considered to be a respective substrate 102. Each wall is preferably porous, such as is shown in the microscopic view of the substrate 102 of FIG. 4. Although not specifically shown in FIG. 4, some of the pores 110 may extend all the way through a given wall (substrate 102) and communicate with an adjacent channel of the honeycomb structure 120. Consequently, the zero valent nanoparticles 106 may exist within such pores 110 that extend all the way through such wall.

A number of experiments were conducted in order to evaluate a number of performance characteristics of the methodologies and apparatus disclosed herein.

In a first example, the pre-treatment process was carried out by adding 1.3 g of an anion exchange resin (specifically DOWEX 550A resin) to 300 ml of FGD wastewater in a glass beaker. The mixture was moderately stirred with a magnetic stir bar for twenty four hours. Thereafter, the resin was permitted to settle out and was then separated from the water by decantation. The pre-treated water was then analyzed to determine the concentrations of anions and heavy metals of interest. The result is TABLE 1, which shows that the anion exchange treatment significantly reduced the levels of the anions, particularly sulfate ions, but also chloride, nitrate, and bromide. In addition, the concentrations of heavy metals were reduced, including selenium, mercury, arsenic, and cadmium.

TABLE 1

| | | |
|---|---|---|
| | Concentration | Concentration |
| Contaminant | Before Treatment | After Treatment |

| | | | | |
|---|---|---|---|---|
| Sulfate | 212 | ppm | 6.2 | ppm |
| Chloride | 182 | ppm | 102 | ppm |
| Nitrate | 185 | ppm | 46 | ppm |
| Bromide | 2.8 | ppm | <0.38 | ppm |
| Selenium | 2.3 | ppm | 0.4 | ppm |
| Mercury | 160 | ppb | 20 | ppb |
| Arsenic | 30 | ppb | 11 | ppb |
| Cadmium | 200 | ppb | 99 | ppb |

Next, the post-treatment process was carried out by immersing a cordierite honeycomb substrate (similar to that shown in FIGS. 5-6) in 45 ml of the pre-treated FGD wastewater. The honeycomb substrate had 40 mg of ZVI nanoparticles supported on 1.2 g of cordierite. The adsorbent in solution was agitated via a mechanical shaker for sixteen hours. The changes in metal ion concentrations due to adsorption were determined and the amounts of adsorbed metal ions were calculated from differences between the concentrations before and after adsorption. The adsorption test data is presented in TABLE 2. It can be seen that the concentrations of all the metals were lowered significantly (well below their detection limits). In particular, the selenium concentration decreased below 5 ppb, which is the National Fresh Water Quality Standard (EPA 2001; EPA 2011).

TABLE 2

| | Concentration | Concentration |
|---|---|---|
| Metal | Before Treatment | After Treatment |
| Selenium | 400 ppb | <5 ppb |
| Mercury | 20 ppb | <1 ppb |
| Arsenic | 11 ppb | <5 ppb |
| Cadmium | 99 ppb | <5 ppb |

For comparison, a second example was carried out without the pre-treatment process, whereby the water was treated only with ZVI nanoparticles. In particular, a cordierite honeycomb substrate (similar to that shown in FIGS. 5-6) was immersed in 45 ml of (untreated) FGD wastewater. The honeycomb substrate had 45 mg of ZVI nanoparticles supported on 1.3 g of cordierite. The adsorption time and the analysis of the wastewater after adsorption were the same as in the first example. The adsorption test result is presented in TABLE 3. It is evident from the result that the adsorbent was effective in removing heavy metals from the untreated FGD wastewater to below their detection limits with the exception of selenium. Based on these results, the ZVI nanoparticle treatment alone will not result in reduction of selenium in high, sulfur-rich contaminated water.

TABLE 3

| | | |
|---|---|---|
| | Concentration | Concentration |
| Metal | Before Treatment | After Treatment |

| | | | |
|---|---|---|---|
| Selenium | 2.3 | ppm | 70 ppb |
| Mercury | 160 | ppb | <1 ppb |
| Arsenic | 30 | ppb | <5 ppb |
| Cadmium | 200 | ppb | <5 ppb |

It is noted that the methodologies, apparatus, and/or mechanisms described in one or more embodiments herein involve the adsorption of the heavy metal onto the functionalized surface (the surface having the immobilized and stabilized zero valent nanoparticles) of the substrate 102. In this regard, the substrate 102 carries the heavy metal contaminant(s) out of or away from the treated water, and therefore the heavy metal remains adsorbed on the substrate 102 after such treatment has been completed. One option for disposing of the heavy metal is simply to discard the used substrate 102, such as in a landfill or other modality. Alternatively, skilled artisans may employ any number of well-known regeneration procedures to remove the heavy metal from the substrate 102 and therefore permit reuse of the substrate 102 in subsequent treatment procedures. The known regeneration procedures fall into two categories: (i) those that selectively remove the heavy metal; and (ii) those that remove at least the zero valent nanoparticles, and possibly the pre-coating and/or stabilizing particles. If the regeneration methodology removes the zero valent nanoparticles and/or the pre-coating and/or the stabilizing particles, then the substrate 102 may be re-functionalized using the techniques described herein to immobilize and stabilize further zero valent nanoparticles on the substrate 102.

Additional aspects of zero valent nanoparticles are disclosed in co-pending U.S. application Ser. No. ______, filed Jun. 26, 2013, entitled “METHODS AND APPARATUS FOR TREATMENT OF LIQUIDS CONTAINING CONTAMINANTS USING ZERO VALENT NANOPARTICLES,” (Attorney Docket No. SP13-174) and in co-pending U.S. application Ser. No. ______, filed Jun. 26, 2013, entitled “METHODS AND APPARATUS FOR SYNTHESIS OF STABILIZED ZERO VALENT NANOPARTICLES,” (Attorney Docket No. SP13-177) the contents of each are hereby incorporated by reference in their entirety.

Although the disclosure herein has been described with reference to particular embodiments, it is to be understood that the details thereof are merely illustrative of the principles and applications of such embodiments. It is therefore to be understood that numerous modifications may be made to the illustrative embodiments and that other arrangements may be devised without departing from the spirit and scope of the present application.

1. A method, comprising:
subjecting water contaminated with one or more heavy metals to an ion exchange process such that a total quantity of anions within the water are reduced; and
subsequent to the anion exchange process, bringing the contaminated water into contact with zero valent nanoparticles to remove at least some of the heavy metal from the water.

2. The method of claim 1, wherein the ion exchange process includes adding anion exchange resin beads to the contaminated water, the beads having pores on the surfaces thereof that are sites for trapping the anions and releasing ions in exchange.

3. The method of claim 2 wherein the anion exchange resin beads are formed from sulphonated cross-linked polystyrene molecules.

4. The method of claim 3 wherein the anion exchange resin beads contain exchangeable hydroxide (OH—).

5. The method of claim 2 wherein the anion exchange resin beads are strongly basic.

6. The method of claim 2 wherein the anion exchange resin beads are of a diameter between one of: (i) about 0.4 to 0.8 mm; (ii) about 0.5 to 0.7 mm; and (iii) about 0.54 to 0.64 mm.

7. The method of claim 2, further comprising separating the anion exchange resin beads from the contaminated water, wherein the separation include decantation.

8. The method of claim 1, wherein the zero valent nanoparticles include at least one of iron, lithium, and nickel.

9. The method of claim 1, wherein the zero valent nanoparticles are immobilized and stabilized on an inorganic substrate and the step of removing the at least some of the heavy metal includes bringing the contaminated water into contact with the zero valent nanoparticles on the substrate.

10. The method of claim 9, wherein the inorganic substrate is one of ceramic and alumina.

11. The method of claim 9, wherein the inorganic substrate is ceramic having a porosity of one of: (i) between about 20%-90%; (ii) between about 40%-70%; and (iii) between about 50%-60%.

12. The method of claim 9, wherein the inorganic substrate is ceramic and the pores are of a size of one of:
(i) between about 20 nm-30 um; (ii) greater than about 20 nm; and (iii) between about 10 um-30 um.

13. The method of claim 9, wherein the zero valent nanoparticles cover a percentage of an active surface area of the at least one surface ranging one of: (i) between about 20%-100%; (ii) between about 40%-90%; (iii) between about 50%-90%; and (iv) between about 70%-80%.

14. The method of claim 9, wherein the inorganic substrate is a ceramic honeycomb structure having a plurality of parallel channels, where each channel is formed by a plurality of interior surfaces on which the zero valent nanoparticles are immobilized and stabilized.

15. The method of claim 14, further comprising flowing the contaminated water through the plurality of parallel channels to bring the water into contact with the zero valent nanoparticles and to remove the heavy metal from the water.
